(19) United States
(12) Patent Application Publication
(10) Pub. No.: US 2025/0260652 A1
(43) Pub. Date: Aug. 14, 2025

(54) Dynamic cache for access to a web service deployed on a server through a telecommunications network

(71) Applicant: ORANGE, Issy-Les-Moulineaux (FR)

(72) Inventors: Olivier Gaste, Chatillon Cedex (FR); Hervé Marchand, Chatillon Cedex (FR)

(21) Appl. No.: 19/052,653

(22) Filed: Feb. 13, 2025

(30) Foreign Application Priority Data
Feb. 14, 2024 (FR) 2401430

(51) Int. Cl. H04L 47/62; G06F 12/0802; H04L 67/02

(52) U.S. Cl. CPC H04L 47/62; G06F 12/0802; H04L 67/02

(57) ABSTRACT

A method for allowing a client to access a web service deployed on a server through a telecommunications network. The method includes: receiving a request designating a requested page associated with the web service, measuring traffic relating to the server, and allocating a cache duration for the requested page based on the measurement.

### CROSS-REFERENCE TO RELATED APPLICATIONS

This application claims priority to French Patent Application No. FR2401430, filed Feb. 14, 2024, the content of which is incorporated herein by reference in its entirety.

### TECHNICAL FIELD

The present disclosure relates to the downloading from a server to a telecommunications client of a web page referencing a set of elements that must be dynamically determined. It particularly applies to web pages of web applications that can cope with significant traffic peaks, such as “web TV” type applications.

### BACKGROUND

A Web TV type application aims to offer the usual services of a connected television from a browser that can connect to a website. A user of a computer or any telecommunications device (such as a digital tablet, Smartphone, etc.) can thus connect to the “web TV” application and view a chosen audio or audio-video program via his browser.

The “Web TV” type applications thus aim to offer a package of audio and/or video content to users, this content being able to be live streamed or time shifted in the form of videos on demand.

Such an application can aggregate content from different sources.

The content offering may vary over time, in particular because audio-video content is inherently linked to the news, but also because content providers may regularly update their offering for marketing reasons.

Also, the content offering may vary depending on the users. They may be registered with the application and have access to content that may therefore depend on their profile, including channels or packages to which they have subscribed.

It therefore appears that the application cannot present a static web page, at least as a home page, but a page dynamically constructed depending on the moment at which the request is received and on the user from whom this request comes.

The web page is then typically made up of a minimal static frame and of references to elements that are dynamically incorporated into the page, in order to construct this web page on demand so that it can be produced on the human-machine interface of the user's browser.

These elements can in particular be determined by computer code (typically in Javascript language) incorporated or referenced in the frame of the web page. This computer code is provided to retrieve the dynamic elements in databases based for example on contextual parameters (user ID, current time, etc.) and on the logic implemented by the computer code.

When it receives a request from a client of a user (telecommunications terminal, computer, etc. hosting a web browser), the server hosting the web application can return the web page frame, leaving it up to the client to execute the computer code and determine and then download the various constituent elements of the web page, in order to produce it on the screen of the terminal.

However, a “web TV” type application may have a commercial purpose. It is then desirable to adapt it in order to obtain the greatest possible visibility on the Web. This visibility requires good referencing with the various search engines.

Therefore, the server hosting the web application cannot return only this web page frame and the computer code because they would not be correctly processed by the search engines. In particular, these search engines are not adapted to execute the computer code and could therefore not retrieve the different constituent elements of the web page. They could then not take into account the content of these pages and therefore could not reference them correctly.

The web page must therefore be constructed by the server and transmitted to the clients, once constructed, that is to say after integration of the different dynamically determined constituent elements.

This type of operation is generally called SSR for “Server Side Rendering”.

This is a technique used in the web development which consists in using scripts on a web server that produces a personalized response for each request from the user (client) on the website. The scripts can be written in any of the available server-side scripting languages (such as JavaScript, PHP, Python, etc.). The SSR differs from the client-side rendering, in which embedded scripts are executed on the client side in a web browser, but the two techniques are often used together. The alternative to either or both types of scripts is that the web server itself provides a static web page.

This technique therefore places a significant load on the server, which must be able to construct the web pages on the fly for each request received from a user. Conventionally, the servers are sized to cope with the load induced by this operation. However, within the context of a Web TV type application, as previously explained, the server must cope with a high variability in the number of requests over time and with extremely large peaks.

For example, before a major event (speech of the President of the Republic, start of a sports competition match, announcement of a disaster, etc.), the server may receive a number of requests several dozen times higher than the nominal rate (a few minutes before).

Sizing the server on the basis of these load peaks would be theoretically possible, but would require on the one hand predicting the maximum intensity of these peaks, and in addition having resources that are far too large for the nominal rate. To the extent that these load peaks can be relatively exceptional or in any case infrequent, this oversizing would be non-optimal in terms of costs for the server operator and detrimental in ecological terms.

There is therefore a need to improve the current proposals of the state of the art.

It is therefore appropriate to find other solutions for improving the experience of the users of the terminals when these are switched on, while minimizing the energy impact.

### SUMMARY

For these purposes, a method allowing a client to access a web service deployed on a server through a telecommunications network is proposed, said method including steps of:
receiving a request designating a requested page associated with said web service,
measuring a traffic relating to said server, and
allocating a cache duration for said requested page based on said measurement.

In this way, a cache duration can be dynamically allocated based on at least one traffic measurement relating to the server. Particularly, this cache duration can be allocated so that the server is less solicited when it is in a loaded state, in order to relieve it. The cache duration can, according to one embodiment, be allocated to a zero or minimal value when the server is not loaded. It is thus possible to establish an optimized balance between the load resting on the servers which can impact the user experience and the need to have a requested page in its most recent version.

According to exemplary aspects, the present disclosure comprises one or more of the following characteristics which can be used separately or in partial combination with each other or in total combination with each other:
The cache duration is higher in case of high traffic.
The requested page references a set of elements called dynamic elements that need to be dynamically determined, at least some of said dynamic elements corresponding to audio-video content. The method can thus be applied to the audio-video content streaming, for example in a CDN type network.
The allocation comprises a comparison between the measurement and a determined threshold, and the duration corresponds to a default value when the measurement is lower than the threshold. Thus, with a default value to 0, the caching mechanism can be triggered only when a certain load is detected, allowing the users to access the most up-to-date data in the nominal operating mode.
The duration is proportional to said measurement, which allows a simple implementation of the proposed method, but other embodiments are possible, such as for example a duration established according to levels determined by a set of thresholds to which said measurement is compared.
Said allocation comprises an incorporation of information relating to said duration in a header of a response to said request. The method can thus be inserted into the protocol exchanges set up, without adding additional messages and therefore traffic.
This information is inserted in a “Cache-control” field within a response compliant with the HTTP protocol.
Said allocation comprises an estimation of an evolution of said traffic measurement and a comparison of said evolution with an objective to determine said duration. It is thus possible to avoid, or at least limit, the appearance of the traffic peaks by reducing the access to the servers even before the appearance of a peak.

Another aspect of the disclosure concerns a server including at least one processor adapted to deploy a web service and to:
receive a request designating a requested page associated with said web service,
measure traffic relating to said server, and
allocate a cache duration for said requested page based on said measurement.

Another aspect of the disclosure concerns a computer program comprising code instructions which, when executed by a processor of a server, carries out the steps of the method as previously described.

Another aspect of the disclosure concerns a data medium on which at least one series of program code instructions has been stored for the execution of a method as previously described.

Other characteristics and advantages of the disclosure will become apparent upon reading the following description of aspects of the present disclosure, given by way of example and with reference to the appended drawings.

### BRIEF DESCRIPTION OF THE DRAWINGS

The appended drawings illustrate exemplary aspects of the present disclosure:

FIG. 1 illustrates a telecommunications network allowing the implementation of a method according to exemplary aspects of the present disclosure;

FIG. 2 schematizes an architecture;

FIG. 3 illustrates a timing diagram according to an aspect of the present disclosure.

### DETAILED DESCRIPTION OF ILLUSTRATIVE ASPECTS OF THE DISCLOSURE

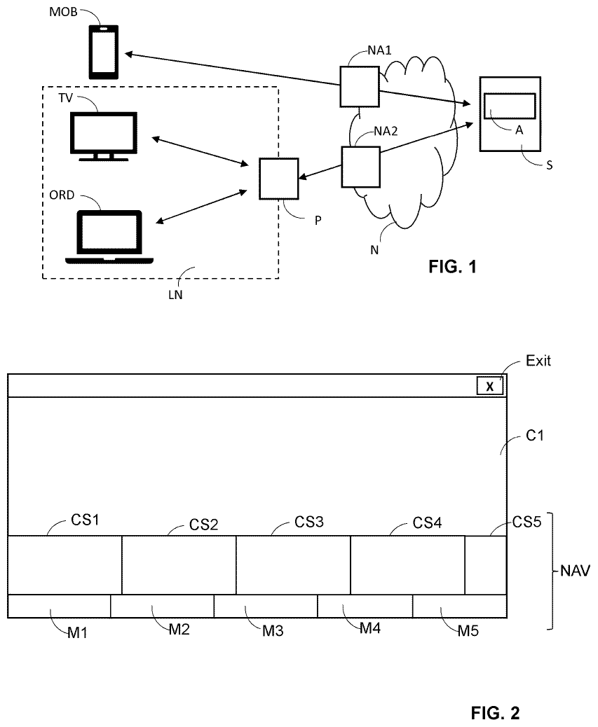

FIG. 1 illustrates a context of implementation of a server S that can host a web application A.

This server S is accessible to clients through a telecommunications network N.

This telecommunications network can be typically composed of several interconnected networks, in particular an access network allowing the clients to connect to a main network (itself made up of an interconnection of sub-networks) or backbone.

The clients can be locally connected to a local network, LN, for example a wireless local network, allowing them to access a gateway P towards the access network. This wireless local area network, commonly called WLAN, can be compliant with the Wi-Fi protocols, or wifi, as specified in the standard documents of the IEEE of the 802.11 (or ISO/IEC 8802-11) family.

The client can also directly access the access network, for example a third, fourth, fifth generation (3G/4G/5G) cellular network for example.

The clients can be of different natures, their common point being to have means allowing the connection to the network. These are essentially radiocommunication components and electronic and computer components allowing the implementation of the protocol stacks required for managing the protocols associated with the network and receiving and emitting data packets.

FIG. 1 represents three types of clients: a computer ORD, a mobile communication terminal MOB, and a connected TV set.

The mobile terminal MOB is typically a Smartphone or a digital tablet. . . . The computer can be a desktop or a laptop.

The TV set can be connected natively or connected through an associated device such as an HDMI stick connected to the TV set.

One example of an external device communicating with a TV set is Chromecast. The Chromecast is a real-time multimedia stream player (multimedia gateway) developed and marketed by Google. The device plugs into the HDMI port of a TV set and communicates, via Wi-Fi connection, with another device connected to the Internet (computer, Smartphone, tablet, etc.), in order to display on the TV set the multimedia content received from an application compatible with Google Cast technology, from the Google Chrome browser present on a computer, or from certain Android devices.

In the illustrative example in FIG. 1, the clients ORD and TV can access the Web application A via the local network LN and the gateway P. The client MOB accesses the Web application A directly via the telecommunications network N.

Access nodes NA1, NA2 allow access to the telecommunications network N, respectively from a mobile client MOB or from a gateway P. These access nodes can be of different types and correspond to different Internet access technologies, allowing a client to access a remote web server.

The two types of access illustrated are essentially aimed at showing the diversity of the possible connections between a client and the web application A, but are in no way limiting the different possibilities available according to the state of the art and still to come.

It should be noted that different intermediate nodes can thus be located on the path of the traffic between clients and web servers.

The clients have software tools adapted to allow the user to connect to a web application and to view content transmitted from this web application. Particularly, in the case of a web application of the Web TV type, the software tool (commonly called web browser) is adapted to allow the production of audio or audio-video content on a human-machine interface associated with the client (client's screen, external screen connected to the client, etc.)

The audio or audio-video content comprises live-streamed content that can be linked to television, radio broadcasting channels, etc. It can also be on-demand content (podcast, video on demand (VOD), etc.).

The web application A is intended to provide, upon request from the clients, web pages referencing different elements.

These elements can correspond to areas of the web page, whose content can be individually determined. For example, in the case of a web TV type application, the elements can correspond to channels, specific video content, menus, advertising spaces, etc.

The elements may be associated with both a visual or graphical representation, and a behavior, in particular when pointed at or selected by the user.

For example, video content may be highlighted or animated differently when pointed at by the user (for example by means of a mouse or a remote control), and be triggered in full screen when selected.

The selection of other elements can result in other actions, such as the opening of a new web page.

Particularly, the first page or home page can be dynamically determined. The web application can also contain dynamically determined pages and static pages (pure HTML code). Some pages can also be a mix of the two, that is to say include static elements and elements to be determined dynamically.

As previously indicated, this page can be compliant with SSR technology.

Server-side rendering (SSR) corresponds to the operation of the traditional websites: the browser sends a request to the server, the latter processes the information and returns an http request containing the complete HTML to the browser, which can then easily perform the rendering.

The server-side rendering SSR allows better compliance with the search engine optimization, SEO, constraints.

According to this mechanism, the server S constructs a page dynamically when it receives a request from a client from a static frame and referenced elements. The server transmits to the client a complete page in HTML (HyperText Markup Language) language with all the tags allowing its good referencing by the search engines.

These referenced (called dynamic) elements need to be dynamically determined. At least some correspond to audio-video content.

FIG. 2 illustrates one example of a graphical interface that can be displayed by a screen associated with a client. This example page can be a home page.

It can correspond to a page transmitted by the server S in response to a request from the client, and constructed dynamically according to the server-side rendering SSR mechanism.

This graphical interface can display, concomitantly, a video content or video stream in an area C1, and a browsing area NAV allowing interactions with the user of the terminal and in particular making it possible to change the video stream to be displayed in the area C1.

The browsing area NAV includes a set of areas CS1, CS2, CS3, CS4, CS5 intended for displaying secondary video streams or content. This secondary content can for example correspond to other television channels.

The selection of a secondary area can trigger the display of the secondary video content in the main area C1. The content previously displayed in this main area C1 can then be displayed in a secondary area. The user can thus zap from one video content to another by means of this graphical interface.

The browsing area can also include menus M1, M2, M3, M4, M5, allowing other browsing options for example to change the multimedia content source: it can be for example connecting to another content server SC, retrieving locally stored multimedia content, etc.

The graphical interface can include other elements not represented in the figure: menus, drop-down menus or the like, accessible for example by means of the selection of a menu M1, M2, ML3, M4, M5, or of a key on a remote control associated with the terminal 10, etc. These elements can provide access to other options, for example to all available television channels.

As previously specified, elements of this page can be dynamically determined in order to reflect the different content, in particular audio-video content, available and accessible to the user according to his profile and to the current time (date and time). The web page therefore references these elements that must be determined dynamically, and which will subsequently be called “dynamic elements”.

The web page may also include static elements, that is to say elements that do not have to be dynamically determined. These static elements do not depend on the news or on the user: they may be general information, graphic elements of the web page that are always present, the CSS style sheet, etc.

According to one embodiment, the web page may be a canvas, or a frame, including very few static elements and mainly consisting of elements that must be determined dynamically (dynamic elements).

The referencing of elements in a web page may be carried out by any known means. These are typically tags or keywords in the HTML language (HyperText Markup Language).

Particularly, the referencing of an element that must be dynamically determined may be done by technical means that allow automatically triggering this determination. These technical means may be links towards resources containing computer code.

This computer code may be scripts written in one of the available server-side scripting languages (such as JavaScript, PHP, Python, etc.).

It is intended to retrieve the dynamic elements in databases based for example on contextual parameters (user identifier, current time, etc.) and on the logic implemented by the computer code. Particularly, it can be intended to retrieve the visuals of a video show, a television channel, a menu, as well as the associated actions (allowing in particular the triggering of the downloading of the associated multimedia content from a content server).

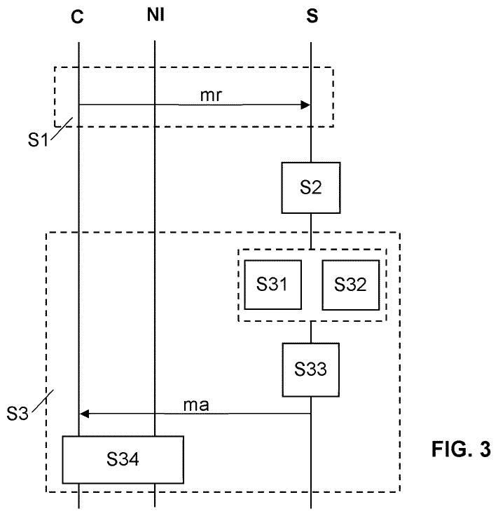

FIG. 3 schematizes a timing diagram according to an aspect of the present disclosure.

In a step S1, the server S receives a request mr designating a requested page.

This page can typically be a home page of a web service deployed on the server S. It can for example be a dynamically constructed home page of a portal for accessing audio-visual content, as previously explained with reference to the illustrative FIGS. 1 and 2.

The request can be issued by any client C, and can pass through at least one intermediate node NI, allowing the routing of the messages between the client and the server S.

The request mr can be compliant with the HTTP protocol (HyperText Transfer Protocol). It can in particular be a GET request of this HTTP protocol.

In a step S2, the server performs or retrieves a measurement of a traffic relating to this server S.

This measurement may concern the load of the server S and therefore its ability to respond to the requests aiming the page concerned or other pages in general, according to a time constraint (that is to say without significantly impacting the experience of the users of the clients C.).

Thus, this step S2 may comprise a monitoring of one or more load criteria of the server S.

These load criteria may comprise:
a number of requests received in a unit of time;
a volume of data emitted in a unit of time;
a load on the server's microprocessor and/or the occupancy of its random access memory;
a number of clients transmitting requests in a unit of time;
etc.

One or more criteria may be evaluated and provide a single or multi-valued measurement representative of the server load (and therefore of its ability to process the requests mr in a satisfactory manner for the users of the clients C).

In a step S3, the server S allocates or assigns a cache duration for the requested page based on the measurement performed in the previous step.

This cache duration may be associated with a response, ma, transmitted by the server S and corresponding to the request mr. This response ma typically corresponds to the page requested and designated by the request mr.

These intermediate nodes may be all or part of the nodes by which this response ma is routed to the client C.

This cache duration may be transmitted independently or via this response message ma.

According to one embodiment, information relating to this duration is incorporated in a header of the response ma to the request.

Particularly, this information can for example be inserted in a Cache-control field within a response ma compliant with the http protocol.

“Cache-control” is a header (or header field) of the HTTP protocol that specifies the caching behavior of the software modules interpreting HTTP messages, in particular the browser of the client C in charge of displaying the requested web page, but also at least some of the intermediate nodes. These particular intermediate nodes have the means to interpret the http messages in order to cache data and reuse them to respond to requests from clients C.

A “cache-control” header contains a set of key/value pairs. Optionally, several values can be associated with a key.

A “max-age” key allows specifying a caching duration. A cache duration can therefore be inserted therein based on the measurement previously performed.

A “public” key allows specifying that adapted NI intermediate nodes can also cache data (and not only the recipient clients C). Preferably, this “public” key is also inserted in order to allow caching the requested page on these intermediate nodes.

Alternatively, the information can be inserted within the header of the web page compliant with the HTML language. For example, an attribute “http-equiv=cache-control” can be provided to control the behavior of the cache memory by the applications interpreting the web page.

Thus, step S3 makes it possible to allocate a cache duration for the requested page to at least some of the equipment by which the response ma is transmitted, that is to say the client C and the intermediate devices NI (as a reminder: not all intermediate equipment is necessarily adapted to perform a caching).

The cache duration is determined based on a traffic measurement relating to the server S.

Particularly, according to one embodiment, this step S3 comprises a reactive mechanism, S31, according to which the cache duration is directly determined based on a measurement. According to this reactive mode, S31, the detection of a traffic peak can thus directly cause the increase of a cache duration in order to curb it.

According to one embodiment, an anticipatory mode S32 can also be set up, aimed at determining a future traffic peak. This anticipation can be based on the detection of a gradual increase in the traffic measurement, and/or on a regression from a history of traffic measurements, making it possible to predict an evolution of the traffic.

Particularly, the cache duration can be determined in order to relieve the server S in the event of high traffic, by allocating a high cache duration. Particularly, the cache duration may be higher in the event of high traffic. Thus, the clients C will use the cached data corresponding to the requested page and, during the caching duration, the server S will not be solicited.

In return, the users of the client C will not have access to any updates to the requested page (this being constructed dynamically by the server S). They will therefore view a potentially old version, out of step with the updates made on the server S. Insofar as the traffic peaks are usually short-term peaks, however, the lag thus caused does not last on the one hand and is not statistically very significant on the other hand. It is thus considered that this degradation of data quality is acceptable in view of the performance gain brought by the reduced load on the server S.

Outside of a traffic peak, the value of the caching duration may be low, so that each call to the web page is the object of a request to the server S, and so that the latter dynamically constructs this page. In this situation, the data concerning this page and stored in the caches of the client and/or of the intermediate nodes NI will be used only during a short time window (which may possibly be reduced to zero).

According to one embodiment, a rule may be defined to automatically determine the cache duration from the traffic measurement. Generally, the cache duration is higher in the event of high traffic, and lower in the event of low traffic. In other words, the cache duration is determined based on the traffic measurement according to an increasing relation.

This rule may be a function, in particular an increasing function, for example linear function. Particularly this duration may be proportional to the measurement.

The duration can also be established according to levels determined by a set of thresholds to which the measurement is compared. This embodiment will be more particularly described later using a concrete example.

According to one embodiment, a reactive mode S31 comprises a comparison between the measurement and a determined threshold. The cache duration can then correspond to a (low) default value when the measurement is lower than said threshold.

When the measurement is higher than the threshold, the cache duration can correspond to a second default value, higher than the first one. Or, the cache duration can be determined by an increasing function depending on the measurement, as explained previously.

In the case of an anticipatory mode, S32, an estimation of an evolution of the traffic measurement can be compared with an objective in order to determine the cache duration. This objective can be a threshold, but also depend on a temporal distance at which this threshold can be crossed: for example, a traffic peak can be detected if it is estimated that the measurement will cross a threshold in less than X minutes.

Over time, the server may be caused to continuously modify the cache durations in order to adapt to traffic fluctuations. Thus, even in the case of an anticipatory mode, the estimations can be continuously revised, in order to adapt the cache duration to the traffic conditions as measured.

In a step S34, the cache duration allocated by the server S is used to parameterize different equipment transmitting the response message ma corresponding to the requested page.

The cache duration is thus used for at least one piece of equipment among the client C and an intermediate node NI connecting the client C and the server S.

This equipment (for example the client C and/or at least one intermediate node NI) can store the requested page and the elements composing it in an associated memory, during a period corresponding to the cache duration.

During subsequent requests, the equipment may accordingly use the content of the memory to directly respond to the client, if the content is still valid (that is to say within the cache duration), or transmit the request to the server S.

The same goes for the client C which, according to the usual mechanisms, checks the content of its own memory before triggering the transmission of a request to the server S.

A case of use of the method concerns the audio-video content delivery networks known by the acronym CDN. In such a context, as previously described, the users of a WebTV service access the service through its home page. This home page is constructed dynamically by the server. The page contains HTML code with all the tags and metadata for SEO (search engine optimization) purposes. The content of the page is dynamic and depends on the programs being streamed (which have just started, the most watched, etc.) as well as on the content in rebroadcast or on demand (VOD for video-on-demand) highlighted (promotion of the most watched content, etc.).

In order to make this content as dynamic as possible (the most up-to-date information), in the nominal situation, the server does not rely on the management of the cache of the nodes of the CDN network or of the web browsers of the client.

To do so, the server positions as http header of the responses the following parameter: “Cache-Control: no-cache, no-store, must-revalidate”.

During load peaks, the server is very heavily solicited.

In order to limit the impact of these load peaks, the server will dynamically position cache management headers.

As previously described, the data caching duration is dynamically adjusted in the server so that the information exposed is not too old while ensuring a reasonable server load. The longer the caching duration, the older the data will be and the less loaded the server will be. The shorter the caching duration (even zero duration), the more up-to-date the data will be and the more loaded the server will be.

The cache management directive is transmitted by the server to the nodes of the CDN and also to the client's browser by the cache management http header: “Cache-Control: public, max-age=xxx” with xxx the caching duration in seconds.

The value of xxx can therefore vary from 1 to a large value (30 for example). The server, depending on its CPU load, can therefore set a more or less large value. A possible rule would be:

| | |
|---|---|
| If CPU load <30% | No cache |
| If CPU load between 30 and 50% | Cache at 1 second |
| If CPU load between 30 and 40% | Cache at 3 seconds |
| If CPU load between 50 and 60% | Cache at 5 seconds |
| If CPU load between 60 and 70% | Cache at 10 seconds |
| If CPU load >70% | Cache at 30 seconds |

As seen previously, other types of rules can be envisaged, as well as a predictive approach for example based on a regression of the evolution of the load.

Thus if the value is set to 5, the server will construct a page for a client, set the “max-age” parameter to 5. The HTML page will then be cached in the different nodes of the CDN. The following users in this 5-second window who pass through this same CDN will then directly use the page cached in the node without soliciting a resource on the server.

Of course, the present disclosure is not limited to the examples and to the embodiments described and represented, but is defined by the claims. It is in particular susceptible of numerous variants accessible to those skilled in the art.

1. A method for allowing a client to access a web service deployed on a server through a telecommunications network, said method being performed by the server and including:
receiving a request designating a requested page associated with said web service;
measuring traffic relating to said server; and
allocating a cache duration for said requested page based on said measurement.

2. The method according to claim 1, wherein said requested page references a set of elements called dynamic elements that need to be dynamically determined, at least some of said dynamic elements corresponding to audio-video content.

3. The method according to claim 1, wherein said allocation comprises a comparison between said measurement and a determined threshold, and said duration corresponds to a default value when said measurement is below said threshold.

4. The method according to claim 1, wherein said duration is proportional to said measurement.

5. The method according to claim 1, wherein said allocation comprises an incorporation of information relating to said duration in a header of a response to said request.

6. The method according to claim 5, wherein said information is inserted in a “Cache-control” field within a response compliant with the Hypertext Transfer Protocol (HTTP protocol).

7. The method according to claim 1, wherein said allocation comprises an estimation of an evolution of said traffic measurement and a comparison of said evolution with an objective to determine said duration.

8. A server comprising:
at least one processor adapted to deploy a web service and to:
receive a request designating a requested page associated with said web service,
measure traffic relating to said server, and,
allocate a cache duration for said requested page based on said measurement.

9. A non-transitory data medium on which at least one series of program code instructions has been stored for execution of a method for allowing a client to access a web service deployed on a server through a telecommunications network, said method comprising:
receiving a request designating a requested page associated with said web service;
measuring traffic relating to said server; and
allocating a cache duration for said requested page based on said measurement.
